(19) United States
(12) Patent Application Publication
(10) Pub. No.: US 2010/0024822 A1
(43) Pub. Date: Feb. 4, 2010

(54) REDUCED PROFILE MULTIPLE GAS CYLINDER ALTERNATIVE

(75) Inventor: Robert L. Leon, Ambler, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: LIFE-PACK TECHNOLOGIES, INC., Ambler, PA (US)

(21) Appl. No.: 11/935,014

(22) Filed: Nov. 5, 2007

Related U.S. Application Data
(60) Provisional application No. 60/859,176, filed on Nov. 15, 2006.

(51) Int. Cl. A62B 9/02; A62B 9/00

(52) U.S. Cl. 128/205.22; 128/205.24

(57) ABSTRACT

An improved self contained breathing apparatus (SCBA) includes a large cylindrical tank of a first diameter having a first weight when holding a first quantity of a breathable gas under a first pressure, an on/off valve, a pressure regulator and a gas distribution device. The improvement comprises replacing the large tank with at least two smaller cylindrical tanks, each of a second diameter which is substantially smaller than the first diameter and a pressure header in fluid communication with each smaller tank and the on/off valve. The smaller tanks and the pressure header have a second combined weight when holding a second quantity of the breathable gas under a second pressure. The second combined weight is substantially the same as or less than the first weight when the first and second pressures are substantially the same and the first and second quantities of the breathable gas are substantially the same.

### CROSS REFERENCE TO RELATED APPLICATIONS

This applications claims priority from U.S. Provisional Patent Application No. 60/859,176 filed Nov. 15, 2006 and entitled “A Reduced Profile Multiple Gas Cylinder Alternative for an SCBA, and Other Tight Space Applications, with Little Impact on Storage Capacity or Weight.”

### BACKGROUND OF THE INVENTION

The present invention relates to improvements in self contained breathing apparatus and other applications in which two or more smaller sized tanks for holding gas under pressure are substituted for a larger tank to provide the same or greater gas capacity with a smaller profile and little or no increase in weight.

Self contained breathing apparatuses are used by many different users including firefighters, divers, rescuers, miners, chemical workers and many others. For brevity, the description of the preferred embodiment of the present application will concentrate primarily on firefighters, it being understood that the concepts and principles described herein are equally applicable to many other types of users.

Firefighters, often wear a self contained breathing apparatus (SCBA) when entering a burning building. The SCBA provides the firefighter with a predetermined quantity of breathable air which will last typically for either 30, 45, or 60 minutes, depending upon the size of the compressed air cylinder or tank and the initial gauge pressure inside the cylinder. The current 30 minute cylinder or tank that firefighters wear on their backs is nearly 6 inches in diameter, and this additional profile can present problems when the firefighter must squeeze through tight spaces, as is often required. What is needed is an SCBA cylinder configuration that provides a smaller profile, with no loss of air capacity, and with little or no weight increase, or alternatively a cylinder configuration that provides such a smaller profile with additional air capacity and only a modest weight increase. Either result would be an improvement over the present situation. In addition to the SCBA tank the firefighters wear on their backs, in the near future firefighters may also wear a life-saving bailout device on their front (such as the Bailout Buddy™ produced and sold by Life-Pack Technologies), and this will further increase the need to reduce the SCBA tank profile. In a much different application such as in hydrogen storage cylinders for use with fuel cell vehicles high capacity and low weight are obviously very important, however equally important is being able to fit the hydrogen storage cylinder(s) into the available space(s) within the vehicle.

The preferred embodiment of the present invention replaces the single large SCBA composite cylinder currently in use by firemen, with two or more, typically side-by-side smaller diameter composite cylinders, all feeding into a common header, to provide the desired reduced profile for the firefighters' SCBA application. If the new composite cylinders were to have approximately half the diameter of the current composite cylinder, four such cylinders would contain approximately the same volume of air as the single current cylinder (not counting the additional volume of the common header). Furthermore, by using new super pressure composite cylinder technology now on the horizon in combination with the present invention, new smaller diameter SCBA cylinders can be made to hold more pressure, so that not only can there be a substantial, up to 50% reduction in profile, but also an increase in capacity from say: 30 minutes to up to 60 minutes (utilizing twice the pressure), all with just a small increase in weight, as will be shown.

### BRIEF SUMMARY OF THE INVENTION

Briefly stated, the present invention, in one embodiment comprises an improved self contained breathing apparatus (SCBA) for use by a firefighter, miner, chemical worker, rescuer, diver or other user. The SCBA includes a single large generally cylindrical tank of a first predetermined outside diameter having a first predetermined weight when holding a first predetermined quantity of a breathable gas under a first predetermined pressure, an on/off valve for permitting or preventing the flow of the breathable gas from the tank, at least one pressure regulator for regulating the pressure of the breathable gas from the tank and a gas distribution device for providing a pressure regulated flow of the breathable gas to the user. The improvement comprises replacing the single large tank with at least two smaller sized generally cylindrical tanks, each smaller tank being of a second predetermined outside diameter which is substantially smaller than the first predetermined outside diameter and a generally tubular pressure header in fluid communication with each smaller tank and with the on/off valve, the smaller tanks and the pressure header having a second predetermined combined weight when holding a second predetermined quantity of the breathable gas under a second predetermined pressure. The second predetermined combined weight is substantially the same as or less than the first predetermined weight when the first and second predetermined pressures are substantially the same and the first and second predetermined quantities of the breathable gas are substantially the same. Pressurized breathable gas from each of the smaller tanks is supplied though the pressure header, on/off switch and the at least one pressure regulator to the distribution device to assist the user in breathing, the second predetermined outside diameter of the smaller tanks providing a reduced profile for the SCBA without an increase in weight to provide increased maneuverability for the user when using the SCBA.

In another embodiment the present invention comprises a self contained breathing apparatus (SCBA) for use by a firefighter, miner, chemical worker, rescuer, diver or other user. The SCBA including two generally cylindrical tanks, each of a predetermined outside diameter which is less than 3.6 inches for holding a predetermined quantity of a breathable gas under a predetermined pressure, a generally tubular pressure header in fluid communication with both of the tanks, an on/off valve in fluid communication with the header for permitting or preventing the flow of the breathable gas from the tanks, at least one pressure regulator for regulating the pressure of the breathable gas from the tanks and a gas distribution device for providing a pressure regulated flow of the breathable gas to the user. Pressurized breathable gas from each of the two tanks is supplied though the pressure header, on/off switch and the at least one pressure regulator to the distribution device to assist the user in breathing, the predetermined outside diameter of the tanks providing a small profile for the SCBA to provide increased maneuverability for the user when using the SCBA.

In yet another embodiment the present invention comprises a self contained breathing apparatus (SCBA) for use by a firefighter, miner, chemical worker, rescuer, diver or other user. The SCBA including four generally cylindrical tanks, each of a predetermined outside diameter which is less than 3 inches for holding a predetermined quantity of a breathable gas under a predetermined pressure, a generally tubular pressure header in fluid communication with each of the tanks, an on/off valve in fluid communication with the header for permitting or preventing the flow of the breathable gas from the tanks, at least one pressure regulator for regulating the pressure of the breathable gas from the tanks and a gas distribution device for providing a pressure regulated flow of the breathable gas to the user. Pressurized breathable gas from each of the tanks is supplied though the pressure header, on/off switch and the at least one pressure regulator to the distribution device to assist the user in breathing, the predetermined outside diameter of the tanks providing a small profile for the SCBA to provide increased maneuverability for the user when using the SCBA.

In yet another embodiment the present invention comprises an improved fuel system for a vehicle operable by the use of a gaseous fuel including a large sized generally cylindrical fuel tank of a predetermined outside diameter having a first predetermined weight when holding a first predetermined quantity of gaseous fuel under a first predetermined pressure and an on/off valve for permitting or preventing the flow of the pressurized gaseous fuel from the large tank. The improvement comprises replacing the single large tank with at least two smaller sized generally cylindrical fuel tanks, each smaller tank being of a second predetermined outside diameter which is substantially smaller than the first predetermined outside diameter and a generally tubular pressure header in fluid communication with each smaller tank and with the on/off valve. The smaller tanks and the pressure header have a second predetermined combined weight when holding a second predetermined quantity of the gaseous fuel under a second predetermined pressure. The second predetermined combined weight is substantially the same as or less than the first predetermined weight when the first and second predetermined pressures are substantially the same and the first and second predetermined quantities of the gaseous fuel are substantially the same. The size of the smaller tanks is such that the smaller tanks may be distributed to differing locations throughout the vehicle so that substantially the same quantity of gaseous fuel under substantially the same pressure may be supplied to the vehicle in a more distributed manner with no substantial increase in weight from the weight of the single large tank.

### DETAILED DESCRIPTION OF THE SEVERAL VIEWS OF THE DRAWINGS

The foregoing summary, as well as the following detailed analyses of the physical principals and detailed description of the preferred embodiment will be better understood when read in conjunction with the appended drawings. For the purpose of illustrating the invention, particular arrangements and methodologies are shown in the drawings. It should be understood, however, that the invention is not limited to the precise arrangements shown or the methodologies of the detailed description. In the drawings:

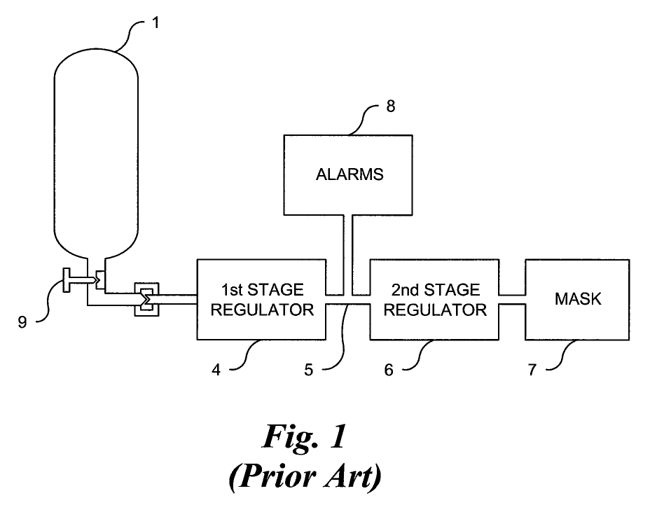

FIG. 1 is a schematic representation of a SCBA employing large sized single prior art cylinder system;

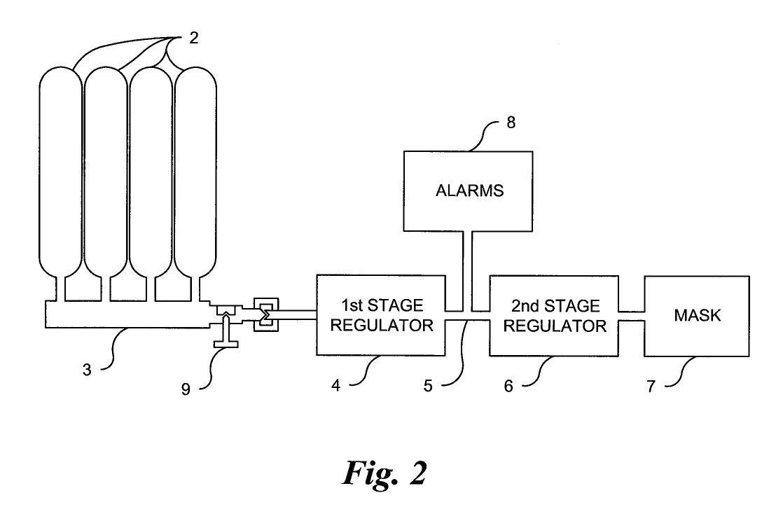

FIG. 2 is a schematic representation of a preferred embodiment of the present invention illustrating reduced profile multiple cylinder system for a firefighters' SCBA;

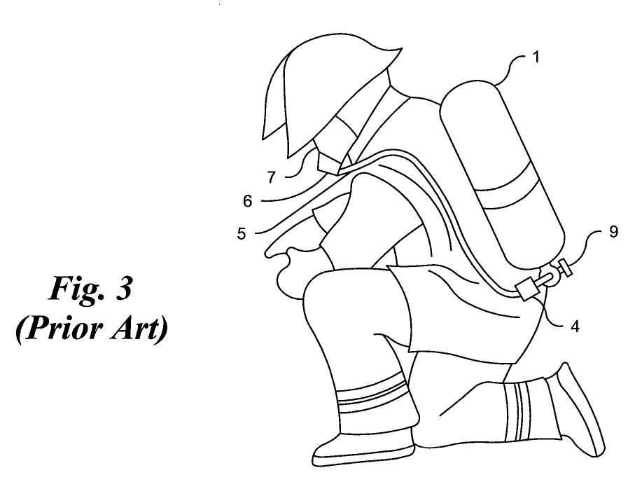

FIG. 3 is a perspective view of a firefighter wearing the prior art single large sized single cylinder SCBA of FIG. 1;

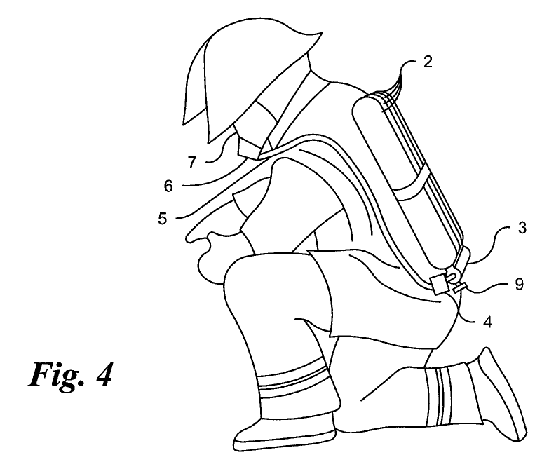

FIG. 4 is a perspective view of a firefighter wearing the reduced profile multiple cylinder system of FIG. 2;

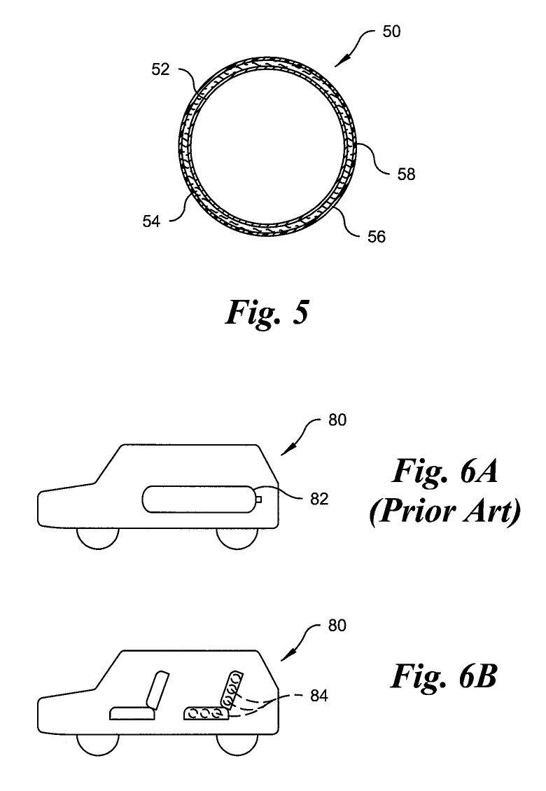

FIG. 5 is a cross sectional view of a gas cylinder used in the preferred embodiment of the present invention illustration the structure;

FIG. 6A is a schematic representation of a gaseous fuel powered vehicle which uses a single large sized gaseous fuel tank in accordance with the prior art; and

FIG. 6B is a schematic representation of a gaseous fuel powered vehicle employing multiple smaller sized gaseous fuel tanks disbursed at spaced locations within the vehicle in accordance with an alternate preferred embodiment of the present invention.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the self contained breathing apparatus and designated parts thereof. Unless specifically set forth herein, the terms “a”, “an” and “the” are not limited to one element but instead should be read as meaning “at least one”. The terminology includes the words noted above, derivatives thereof and words of similar import.

FIG. 1 is a schematic diagram of a single large sized air cylinder or tank 1 in conjunction with a typical prior art firefighters' SCBA. The single large sized cylinder 1 has a first predetermined outside diameter typically about or slightly less than six inches and a first predetermined weight when holding a first predetermined quantity of a breathable gas, typically air, initially under a first predetermined pressure. Cylinder 1 with an on/off valve 9 for permitting or preventing air the flow of the air from the cylinder 1 is connected to, and in fluid communication with a at least one pressure regulator including a first stage pressure regulator 4 which reduces the pressure of the air from the cylinder 1 down to about 100 psig. A flexible hose 5 connects the air at the reduced pressure to a gas distribution device, in the present embodiment a mask 7 which includes a second pressure regulator 6 (the second stage regulator) for providing a pressure regulated flow of air to a firefighter at very low pressure, either in a demand mode where inhaling reduces the pressure below atmosphere to cause the air to flow, or in a pressure demand mode where the pressure in the mask 7 remains above atmosphere at all times to keep the firefighter from breathing bad air due to mask leakage. The SCBA also contains various safety features and alarms 8 to alert the firefighter or others when the air pressure within the cylinder 1 is running low so the firefighter can replace the cylinder 1 or leave the area and go to where breathable ambient air is available.

FIG. 3 shows a typical firefighter wearing the above described prior art SCBA with its cumbersome single large sized cylinder 1. The first stage regulator 4 is located near the outlet of cylinder 1 after the on/off valve 9, and it is connected by a flexible hose 5 to the second stage regulator 6 which is located in or attached to mask 7.

FIG. 2 is a schematic diagram of the preferred embodiment of an improved, reduced profile multiple cylinder system of the present invention for a SCBA application. As shown, the single large sized cylinder 1 of the prior art SCBA shown in FIGS. 1 and 3 has been replaced by at least two (four shown) smaller sized gas cylinders or generally cylindrical tanks 2. Each of the smaller cylinders 2 is of a second predetermined outside diameter which is substantially smaller than the first predetermined diameter of the larger tank 1. Each smaller cylinder 2 is connected in fluid communication with a generally tubular common high pressure header or manifold 3 which is also in fluid communication with the on/off valve 9. The smaller tanks 2 and the pressure header 3 have a second predetermined combined weight when holding a second predetermined quantity of breathable gas under a second predetermined pressure. When the first and second predetermined pressures are the same or substantially the same and the first and second quantities of the breathable gas are the same or substantially the same the second combined predetermined weight is the same or substantially the same as or less than the first predetermined weight. In this manner, air from each of the smaller sized cylinders 2 is supplied to the mask 7 in the same manner as with the larger cylinder 1. However, the reduced profile for a SCBA employing the smaller sized cylinders 2 provides more maneuverability for the firefighter without an increase in weight. If the firefighter wanted to carry more air so that the second predetermined quantity of air is greater than the first predetermined quantity of air, the second predetermined pressure would be greater than the first predetermined pressure but the second predetermined weight would be no more than slightly greater than the first predetermined weight while still maintaining the reduced profile for the SCBA.

In the illustrated SCBA application, the axis of the common header 3 is substantially a straight line, but it needn't be straight in an alternate embodiment if, for a particular application, it is more advantageous to use a non-straight header to take maximum advantage of the reduced cylinder profiles afforded by the present invention. The common pressure header 3 is essentially a tube, or a series of interconnected tubes, in fluid communication, having openings to each of the smaller sized cylinders 2 substantially perpendicular to the header axis and having an outlet opening connected to the on/off valve 9 which is either substantially perpendicular to the header axis or substantially in-line with it. The cylinders 2 may be connected to the header 3 by standard or special pressure fittings, welding or in any other suitable manner. In the preferred embodiment, the common header 3 with the connected on/off valve 9 is connected and in fluid communication with the SCBA's first stage regulator 4, which in turn, is connected to a flexible hose 5, and the second stage regulator 6, in the mask 7, essentially the same as for the prior art large single cylinder SCBA as shown in FIGS. 1 and 3. While in the preferred embodiment four smaller sized cylinders 2 are present, it will be appreciated that a lesser number of smaller sized cylinders 2 (such as two or three) or a greater number of smaller sized cylinders 2 could be employed in particular applications.

In will be appreciated that the present invention is not limited to use by a firefighter. A reduced profile SCBA in accordance with the present invention could also be used by a diver, rescuer, miner, chemical worker or virtually any other user in any other environment that requires breathing assistance. Additionally, while in the present embodiment the breathable gas that is supplied is air, it will be appreciated by those skilled in the art that some other breathable gas such as pure oxygen or oxygen combined with at least one other gas, such as nitrogen, could be held in the smaller sized cylinders 2. Further, while in the present embodiment the pressure regulated breathable gas or air is provided to the firefighter by a mask 7, it should be understood that some other kind of gas distribution device such as a mouthpiece, nosepiece or the like may alternatively be used in other applications. For example for a diver, an oxygen mixture may be used in the cylinders 2 and a mouthpiece may be used for delivering the breathable gas to the diver.

FIG. 4 shows the same firefighter as shown in FIG. 3 wearing the reduced profile multiple (four) cylinder SCBA shown in FIG. 2 having half the profile of the single cylinder SCBA of FIG. 3, yet with the same air capacity, the same initial air pressure, and approximately the same overall weight. Clearly, the firefighter shown in FIG. 4 can more easily squeeze through tight spaces, if necessary, than the firefighter with the more cumbersome single cylinder shown in FIG. 3. The space advantage afforded by the reduced profile of the preferred embodiment of the present invention obtained by using the small diameter multiple cylinders 2 is readily apparent. Less apparent is the assertion that the SCBA of the preferred embodiment contains the same initial quantity of air (at the same initial pressure) and that it weighs about the same as the prior art single large cylinder SCBA of FIG. 3.

In general, for a bare metal cylindrical pressure vessel, the meridional stress s₁ (measured along the intersection of the wall and a plane containing the cylinder axis) is:

pD/4t

and the circumferential stress s₂ (measured along the intersection of the wall and a plane normal to the cylinder axis) is:

pD/2t

### Where:

p is the gauge pressure (the difference between the inside pressure and the outside pressure),

D is the diameter, and

t is the wall thickness.

Thus the membrane stresses (both meridional and circumferential) are directly proportional to the gauge pressure and the diameter, and inversely proportional to the wall thickness. Therefore, if the diameter of the cylinder were to be halved, as shown in FIG. 2, the wall thickness could also be halved and still maintain the same stress level at the same pressure. With half the diameter and half the wall thickness, the cylinder would have one-quarter of the weight and one-quarter of the volume. And so four half-size cylinders 2 would weigh about the same as one full-size cylinder 1, and contain approximately the same amount of air at a given pressure. This supports the assertion that the SCBA (cylinder) profile can be halved and the air capacity kept the same (at the same initial pressure) while the weight is kept the same or substantially the same.

Most of today's SCBA air cylinders are composite pressure vessels, not just bare metal. In a composite vessel 50 as shown in FIG. 5, the bare metal internal aluminum cylinder 52 is wrapped with carbon fibers 54, covered with a layer of fiberglass 56, impregnated with epoxy resin 58, and cured. When the pressure is increased internally in such composite cylinders 50 the radial expansion that would normally take place in a bare metal vessel is resisted by the carbon fibers 54 and thus less radial expansion and less membrane stress results. This permits the internal aluminum cylinders 52 to be thinner so that the resulting carbon fiber wrapped composite cylinder 50 is lighter because the impregnated carbon fiber jacket weighs less than the aluminum it replaces. With the present carbon fiber composite technology, the upper limit is 35 Mpa (or about 5,000 psi), and as a direct consequence, the maximum pressure utilized for today's SCBA cylinders is about 4,500 psi. Few if any bare aluminum cylinders today are designed to handle that much internal pressure.

Spurred on by the potential need for onboard super high pressure hydrogen storage cylinders (with their resulting increased capacity) for use with future automotive fuel cells, composite carbon fiber cylinder technology is about to attain another pressure plateau: 70 Mpa (or approximately 10,000 psi) by using more carbon fibers more efficiently. This advance should enable SCBA cylinders to effectively double in pressure to about 9,000 psi. In SCBA single cylinder systems, the increased pressure may allow for some modest reduction in profile when there is little or no increase in capacity. But when utilized in conjunction with the present invention, not only may it be possible to more than halve the SCBA profile, but the SCBA cylinder capacity could be doubled from about 30 minutes to about 60 minutes with just a modest increase in weight (and where much of that weight increase is just the increase in stored air weight).

When computing the charged cylinder weight, in addition to the weight of the empty cylinder, the weight of the compressed air must be taken into account. In SCBA cylinders, 30 minutes of air is approximately 45 standard cubic feet (scf) at 14.7 psi and 60° F. Since 1 scf of air weighs 0.078 lbs, 45 scf weighs 3.5 lbs. Therefore, increasing the pressure from 4,500 psi to 9,000 psi would not only double the scf of air (and the duration from 30 minutes to 60 minutes), and it would also increase the air weight from about 3.5 lbs to about 7.0 lbs.

Utilizing the current 4,500 psi single cylinder, wrapped carbon fiber technology, the typical 30 minute cylinder weighs approximately 8.5 lbs with valve and hardware, and the typical 60 minute cylinder (usually with 87 scf of air) weighs approximately 15 lbs with valve and hardware. Going from the 30 minute cylinder with 45 scf of air to the 60 minute cylinder with 87 scf of air, the air weight goes from 3.5 to nearly 7.0 lbs, and so the fully charged cylinder weight goes from about 12 lbs for 30 minutes to about 22 lbs for 60 minutes, and the diameter increases from about 5.5 inches to about 7.2 inches. Thus, despite the added assurance of a 60 minute air supply, the approximate 10 pounds of added weight plus the increase in cylinder profile from about 5½ inches to over 7 inches causes most firefighters to opt for the 30 minute cylinder, not the 60 minute cylinder.

With the present invention, a firefighter will be able to get more than 30 minutes of air with a fully charged 4,500 psi cylinder system weighing about 13 lbs (including the header weight and header volume) but having a profile of only about 2¾ inches. And utilizing the coming super pressure carbon fiber wrapped technology which will enable 9,000 psi, a firefighter could conceivably get more than 60 minutes of air with a fully charged reduced profile cylinder system that weighs about 17 lbs and has a profile of approximately 3 inches. Either case would provide a significant improvement, certainly with respect to the profile.

One method of quantifying the degree of improvement provided by the reduced diameter multiple cylinder approach over the single cylinder case is to compute the term:

DI=[capacity ratio(new/old)/(total weight ratio(new/old)×profile ratio(new/old))],

where the degree of improvement is indicated by how much the DI value exceeds 1.000. But in the end, the only truly meaningful measure is whether the desired reduced profile and capacity (or duration) can be obtained without an unacceptable total weight gain.

An alternate preferred embodiment of the present invention is directed to an improved storage cylinder or tank for storing a gaseous fuel, in the present embodiment hydrogen for propelling a vehicle 80 (FIG. 6A) operable by use of the gaseous fuel. For the hydrogen storage cylinder application which is intended for future fuel cell vehicles, an alternate embodiment of the present invention can be used by a vehicle designer to squeeze multiple reduced-profile super high pressure hydrogen storage cylinders 84 and an on/off valve into an optimum vehicle design, rather than the reverse, and possibly impossible, task of trying to design a practical vehicle around a single large diameter, heavy, super high pressure storage cylinder 82. (Samtech International is developing a large aluminum/carbon fiber composite 70 Mpa super high pressure hydrogen stock cylinder that will make it possible for a vehicle to complete a 500 km run on one filling.) But by using the alternate embodiment of the present invention, at least two but preferably more than two smaller diameter (low-profile) super pressure cylinders 84 (FIG. 6B) can each be attached in fluid communication to a generally tubular header (or more than one header, all connected) which may be snaked through the many available storage spaces of the vehicle 80. The larger sized cylinder 82 has a first predetermined outside diameter and a first predetermined weight when holding a first predetermined quantity of a gaseous fuel under a first predetermined pressure. The smaller tanks 84 and the pressure header have a second predetermined combined weight when holding a second predetermined quantity of the gaseous fuel under a second predetermined pressure. When the first and second predetermined pressures are the same or substantially the same and the first and second predetermined quantities of the gaseous fuel are the same or substantially the same, the second predetermined combined weight is substantially the same as or less than the first predetermined weight so no weight is added to the vehicle by using the smaller cylinders 84. This permits a designer to take the maximum advantage of the available vehicle spaces, while not sacrificing the high storage capacity or low total (charged) weight of the single large super high pressure composite cylinder 82 the smaller sized cylinders 84 are intended to replace. Further, the use of the smaller tanks permits the storage of an increased quantity of gaseous fuel at an increased pressure with little or no increase in weight.

Although the preferred embodiment of the present invention for the reduced profile SCBA application has been described and specified in significant detail and the alternate preferred embodiment for the fuel cell vehicle gaseous fuel storage application has also been described, alternate arrangements and other applications still within the scope of the present invention are feasible. It will also be appreciated by those skilled in the art that alternate uses may be found that differ from the proposed uses, and that changes or modifications could be made to the above-described embodiments without departing from the broad inventive concepts of the invention. Therefore it should be appreciated that the present invention is not limited to the particular uses or particular embodiments disclosed but is intended to cover all uses and all embodiments within the scope or spirit of the described invention as defined by the appended claims.

I claim:

1. In a self contained breathing apparatus (SCBA) for use by a firefighter, miner, chemical worker, rescuer, diver or other user, the SCBA including a single large generally cylindrical tank of a first predetermined outside diameter having a first predetermined weight when holding a first predetermined quantity of a breathable gas under a first predetermined pressure, an on/off valve for permitting or preventing the flow of the breathable gas from the tank, at least one pressure regulator for regulating the pressure of the breathable gas from the tank and a gas distribution device for providing a pressure regulated flow of the breathable gas to the user wherein the improvement comprises replacing the single large tank with:
at least two smaller sized generally cylindrical tanks, each smaller tank being of a second predetermined outside diameter which is substantially smaller than the first predetermined outside diameter; and
a generally tubular pressure header in fluid communication with each smaller tank and with the on/off valve, the smaller tanks and the pressure header having a second predetermined combined weight when holding a second predetermined quantity of the breathable gas under a second predetermined pressure,
whereby the second predetermined combined weight is substantially the same as or less than the first predetermined weight when the first and second predetermined pressures are substantially the same and the first and second predetermined quantities of the breathable gas are substantially the same and
whereby pressurized breathable gas from each of the smaller tanks is supplied though the pressure header, on/off switch and the at least one pressure regulator to the distribution device to assist the user in breathing, the second predetermined outside diameter of the smaller tanks providing a reduced profile for the SCBA without an increase in weight to provide increased maneuverability for the user when using the SCBA.

2. The improved self contained breathing apparatus as recited in claim 1 wherein when the second predetermined quantity of the breathable gas is substantially greater than the first predetermined quantity of the breathable gas, the second predetermined pressure is substantially greater than the first predetermined pressure and the second predetermined weight is the no more than slightly greater than the first predetermined weight.

3. The improved self contained breathing apparatus as recited in claim 1 wherein the breathable gas comprises one of the group consisting of air, oxygen and a combination of oxygen and at least one other gas.

4. The improved self contained breathing apparatus as recited in claim 1 wherein the gas distribution device comprises at least one of a mask, a mouthpiece and a nosepiece.

5. The improved self contained breathing apparatus as recited in claim 1 wherein the first predetermined diameter is greater than 5 inches and when the number of smaller tanks is two, the second predetermined diameter is less than 3.6 inches.

6. The improved self contained breathing apparatus as recited in claim 1 wherein the first predetermined diameter is greater than 5 inches and when the number of smaller tanks is four, the second predetermined diameter is less than 3 inches.

7. A self contained breathing apparatus (SCBA) for use by a firefighter, miner, chemical worker, rescuer, diver or other user, the SCBA including two generally cylindrical tanks, each of a predetermined outside diameter which is less than 3.6 inches for holding a predetermined quantity of a breathable gas under a predetermined pressure, a generally tubular pressure header in fluid communication with both of the tanks, an on/off valve in fluid communication with the header for permitting or preventing the flow of the breathable gas from the tanks, at least one pressure regulator for regulating the pressure of the breathable gas from the tanks and a gas distribution device for providing a pressure regulated flow of the breathable gas to the user, whereby pressurized breathable gas from each of the two tanks is supplied though the pressure header, on/off switch and the at least one pressure regulator to the distribution device to assist the user in breathing, the predetermined outside diameter of the tanks providing a small profile for the SCBA to provide increased maneuverability for the user when using the SCBA.

8. The self contained breathing apparatus as recited in claim 7 wherein the breathable gas comprises one of the group consisting of air, oxygen and a combination of oxygen and at least one other gas.

9. The self contained breathing apparatus as recited in claim 7 wherein the gas distribution device comprises at least one of a mask, a mouthpiece and a nosepiece.

10. A self contained breathing apparatus (SCBA) for use by a firefighter, miner, chemical worker, rescuer, diver or other user, the SCBA including four generally cylindrical tanks, each of a predetermined outside diameter which is less than 3 inches for holding a predetermined quantity of a breathable gas under a predetermined pressure, a generally tubular pressure header in fluid communication with each of the tanks, an on/off valve in fluid communication with the header for permitting or preventing the flow of the breathable gas from the tanks, at least one pressure regulator for regulating the pressure of the breathable gas from the tanks and a gas distribution device for providing a pressure regulated flow of the breathable gas to the user, whereby pressurized breathable gas from each of the tanks is supplied though the pressure header, on/off switch and the at least one pressure regulator to the distribution device to assist the user in breathing, the predetermined outside diameter of the tanks providing a small profile for the SCBA to provide increased maneuverability for the user when using the SCBA.

11. The self contained breathing apparatus as recited in claim 10 wherein the breathable gas comprises one of the group consisting of air, oxygen and a combination of oxygen and at least one other gas.

12. The self contained breathing apparatus as recited in claim 10 wherein the gas distribution device comprises at least one of a mask, a mouthpiece and a nosepiece.

13. In a vehicle operable by the use of a gaseous fuel including a large sized generally cylindrical fuel tank of a predetermined outside diameter having a first predetermined weight when holding a first predetermined quantity of gaseous fuel under a first predetermined pressure and an on/off valve for permitting or preventing the flow of the pressurized gaseous fuel from the large tank wherein the improvement comprises replacing the single large tank with:
at least two smaller sized generally cylindrical fuel tanks, each smaller tank being of a second predetermined outside diameter which is substantially smaller than the first predetermined outside diameter; and
a generally tubular pressure header in fluid communication with each smaller tank and with the on/off valve, the smaller tanks and the pressure header having a second predetermined combined weight when holding a second predetermined quantity of the gaseous fuel under a second predetermined pressure,
whereby the second predetermined combined weight is substantially the same as or less than the first predetermined weight when the first and second predetermined pressures are substantially the same and the first and second predetermined quantities of the gaseous fuel are substantially the same and
whereby the size of the smaller tanks is such that the smaller tanks may be distributed to differing locations throughout the vehicle so that substantially the same quantity of gaseous fuel under substantially the same pressure may be supplied to the vehicle in a more distributed manner with no substantial increase in weight from the weight of the single large tank.

14. The improved vehicle fuel system as recited in claim 13 wherein the gaseous fuel comprises hydrogen or a combination of hydrogen and at least one other gas.

15. The improved vehicle fuel system as recited in claim 13 wherein when the second predetermined quantity of the gaseous fuel is substantially greater than the first predetermined quantity of the gaseous fuel, the second predetermined pressure is substantially greater than the first predetermined pressure and the second predetermined weight is the no more than slightly greater than the first predetermined weight.
